(19) United States
(12) Patent Application Publication
(10) Pub. No.: US 2003/0006062 A1
(43) Pub. Date: Jan. 9, 2003

(54) Interconnect system and method of fabrication

(76) Inventors: William M. Stone, Austin, TX (US); Trent Uehling, New Braunfels, TX (US); Brian D. Sawyer, Austin, TX (US); Douglas G. Mitchell, Tempe, AZ (US)

Correspondence Address: MOTOROLA INC, AUSTIN INTELLECTUAL PROPERTY, LAW SECTION, 7700 WEST PARMER LANE MD: TX32/PL02, AUSTIN, TX, 78729

(21) Appl. No.: 09/900,365

(22) Filed: Jul. 6, 2001

(51) Int. Cl. H02G 3/08

(52) U.S. Cl. 174/255

(57) ABSTRACT

Embodiments of the present invention relate generally to interconnect systems. One embodiment relates to an interconnect system having a first substrate, and a standoff that extends from said first substrate. The interconnect system further includes a cap, intended for subsequent reflow attachment, that covers a first end of the standoff and does not cover the sides of the standoff. The interconnect system further includes a nonwettable surface layer on the sides of the standoff such that the cap is prevented from substantially wetting the sides of the standoff when the cap is in a fluid state. The interconnect system may further include a second substrate attached to the cap where substantially all of the cap is located at the first end of the standoff. Another embodiment of the present inventions relates to a method of fabricating the interconnect system.

### FIELD OF THE INVENTION

The present invention relates generally to interconnect systems, and more specifically to flip-chip interconnect systems.

### RELATED ART

When assembling flip-chip interconnect systems, the diameter of interconnects between the die and substrate provides geometric limitations to reducing pitch of the interconnects. Also, in flip-chip interconnect systems, as pitch is reduced, solder volume at the interconnect points at the substrate is also reduced; thus reducing the standoff between the semiconductor die and the substrate and producing a less reliable solder connection. Therefore, a need exists for an interconnect system that allows for finer pitch while maintaining interconnect reliability.

### BRIEF DESCRIPTION OF THE DRAWINGS

The present invention is illustrated by way of example and not limitation in the accompanying figures, in which like references indicate similar elements, and in which:

FIGS. 1-7 illustrate cross sectional views of an interconnect system in accordance with one embodiment of the present invention; and

FIGS. 8 and 9 illustrate cross sectional views of an interconnect system in accordance with an alternate embodiment of the present invention.

Skilled artisans appreciate that elements in the figures are illustrated for simplicity and clarity and have not necessarily been drawn to scale. For example, the dimensions of some of the elements in the figures may be exaggerated relative to other elements to help improve the understanding of the embodiments of the present invention.

### DETAILED DESCRIPTION

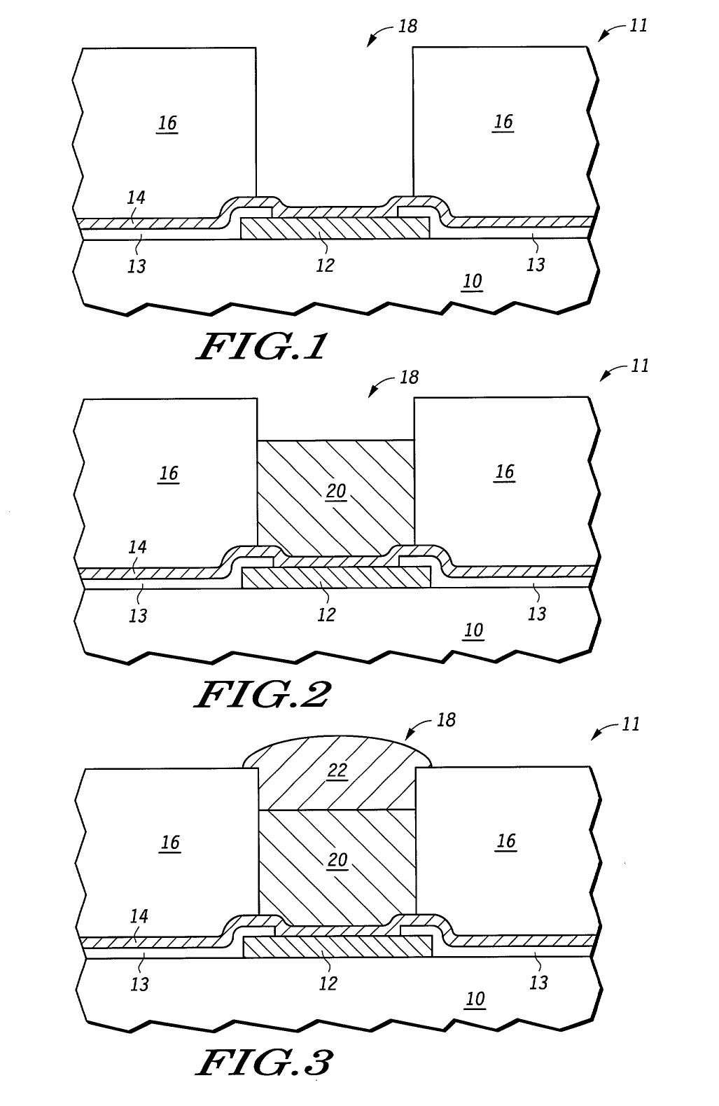

FIG. 1 illustrates a cross sectional view of a portion of an interconnect system 11. Interconnect system 11 includes a semiconductor die 10 having a conductive pad 12 overlying semiconductor die 10. Interconnect system 11 is used to connect semiconductor die 10 to a substrate, where semiconductor die 10 may include an integrated circuit (not shown) formed within the substrate of semiconductor die 10. (Note that conventional processing techniques may be used to form semiconductor die 10.) Conductive pad 12 overlies semiconductor die 10 and is electrically coupled to the integrated circuit within semiconductor die 10. Interconnect system 11 may also include a passivation layer 13 overlying semiconductor die 10 and portions of conductive pad 12. Passivation layer 13 also includes an opening that overlies pad 12. Passivation layer 13 may be deposited over semiconductor die 10 using, for example, a chemical vapor deposition (CVD) technique. In one embodiment, passivation layer 13 may include silicon oxide, silicon nitride, silicon oxynitride, or the like. A portion of passivation layer 13 is then removed to form the opening over conductive pad 12. (Note that passivation layer 13 may be patterned and etched to form the desired openings using conventional etching techniques.)

Seed layer 14 overlies passivation layer 13 and conductive pad 12 (within the opening in passivation layer 13). Seed layer 14 may be a plating bus for use in an electroplating process. For example, seed layer 14 may be used for electroplating a copper standoff, as will be discussed further below. Seed layer 14 may also include a plurality of films to form an underbump metallurgy (UBM), such as, for example, a Titanium-Tungsten UBM. These various films may be used for their different properties, such as, for example, adhesion, barrier, and plating properties. In one embodiment, sputtering is used to form seed layer 14. Interconnect system 11 also includes a masking layer 16, overlying layer 14, where masking layer 16 may be any conventional photoresist layer. Masking layer 16 has an opening 18 overlying conductive pad 12.

FIG. 2 illustrates a standoff 20 formed within opening 18 of the masking layer 16. Standoff 20 may be formed by electroplating, electroless plating, evaporating, sputtering, etc. In one embodiment, standoff 20 includes a copper standoff that is electroplated using seed layer 14. In alternate embodiments, standoff 20 may include other materials such as aluminum, nickel, lead, gold, or any conductive material or alloy having a higher melting temperature than the solder to be formed over standoff 20. In one embodiment, standoff 20 may have a thickness of at least approximately 10 microns. Alternatively, standoff 20 may have a thickness of at least approximately 20 microns. Alternatively, standoff 20 may have a thickness of approximately 25 to 35 microns. In yet another embodiment, standoff 20 may have a thickness of at least approximately 35 microns. Therefore, standoff 20 could be formed having a variety of different thicknesses.

FIG. 3 illustrates a solder cap 22 formed within opening 18, over standoff 20. Portions of solder cap 22 may also be formed over masking layer 16, as illustrated in FIG. 3. Solder cap 22 may be formed using a variety of processes, such as, for example, electroplating, evaporative, sputtering, screen printing processes. In one embodiment, solder cap 22 includes a eutectic material, such as, for example, a 63% tin/37% lead eutectic material. Alternatively, solder cap 22 may include any other appropriate solder material or combination of materials that may be at least partially liquified to form an electrical connection. Examples may include high lead, tin/copper, tin/copper/bismuth, lead/tin/silver, tin/silver, tin/copper/silver, etc.

FIG. 4 illustrates interconnect system 11 after removal of masking layer 16 and portions of seed layer 14 underlying masking layer 16. Masking layer 16 may be removed using, for example, resist strip chemicals such as N-Methylpyrrolidone (NMP). If seed layer 14 includes copper, it may be removed using an etchant commercially available under the name Metex (which is a trademark of MacDermid, Inc. of Waterbury, Conn.). If seed layer 14 includes copper and titanium, a peroxide ethylenedinitrilo tetraacetic acid (EDTA) etchant may be used. Therefore, a variety of different resist strip chemicals and etchants may be used to remove masking layer 16 and seed layer 14, depending upon the materials used.

In FIG. 5, an oxide layer 24 is formed along both sides of standoff 20 and seed layer 14. In one embodiment, oxide layers 24 may be a grown oxide layer formed by exposing standoff 20 and seed layer 14 to an oxygen-containing environment. In an alternate embodiment, oxide layers 24 may be formed by baking standoff 20 and seed layer 14 in an oxygen-containing environment. Alternatively, the processes illustrated in reference to FIGS. 4 and 5 may be combined such that a residual oxide layer may be formed when masking layer 16 or seed layer 14 is removed. Therefore, in this embodiment, the resulting structure would be as illustrated in FIG. 5 where oxide layers 24 would be residual oxide layers. For example, a peroxide EDTA etchant can be used to remove a copper titanium-tungsten seed layer such that a copper oxide would remain as oxide layers 24. Note that if subsequent reflows are used (such as after attaching solder cap 22 to a substrate), portions of oxide layers 24 may be removed due to the flux used within the reflow step. Therefore, oxide layers 24 can be made thick enough along the sides of standoff 20 to resist being completely removed by the subsequent flux. Alternatively, a weaker flux may be chosen such that it does not attack, or only minimally attacks, oxide layers 24. Thus, many different processes may be used to form oxide layers 24. For example, as discussed above, oxide layers 24 may be a grown oxide or a residual oxide, and may be formed using a separate processing step, or within other existing processing steps.

The formation of oxide layer 24 allows the sides of standoff 20 and seed layer 14 to become nonwettable surfaces. That is, the solder of solder cap 22 will not wet, or will only minimally wet, to the oxide layers 24, thus allowing solder cap 22 to remain concentrated on the top of standoff 20 rather than losing volume along the sides of standoff 20. Therefore, alternate embodiments may use other processes for preventing the wetting of solder cap 22 to standoff 20. For example, in alternate embodiments, the materials of standoff 20 and solder cap 22 may be selected such that the properties of the materials prevent the wetting of solder cap 22 to standoff 20. In this embodiment, an adhesion layer may be needed to adhere solder cap 22 to standoff 20. For example, if standoff 20 were aluminum, an adhesion layer including nickel and gold could be used to adhere solder cap 22 to the aluminum standoff. Furthermore, layers other than oxide layers may be formed on the sides of standoff 20 to prevent wetting of solder cap 22. For example, in removing masking layer 16, portions of masking layer 16 may be left on the sides of standoff 20. Therefore, rather than oxide layers 24, residual portions of masking layer 16 may be used instead to prevent the wetting of solder to the sides of standoff 20. Therefore, nonwettable surfaces refer to those surfaces that allow less than approximately 20% of the surface area to be covered. In alternate embodiments, nonwettable surfaces may allow less than approximately 10%, or even less than approximately 5%, of the surface area to be covered.

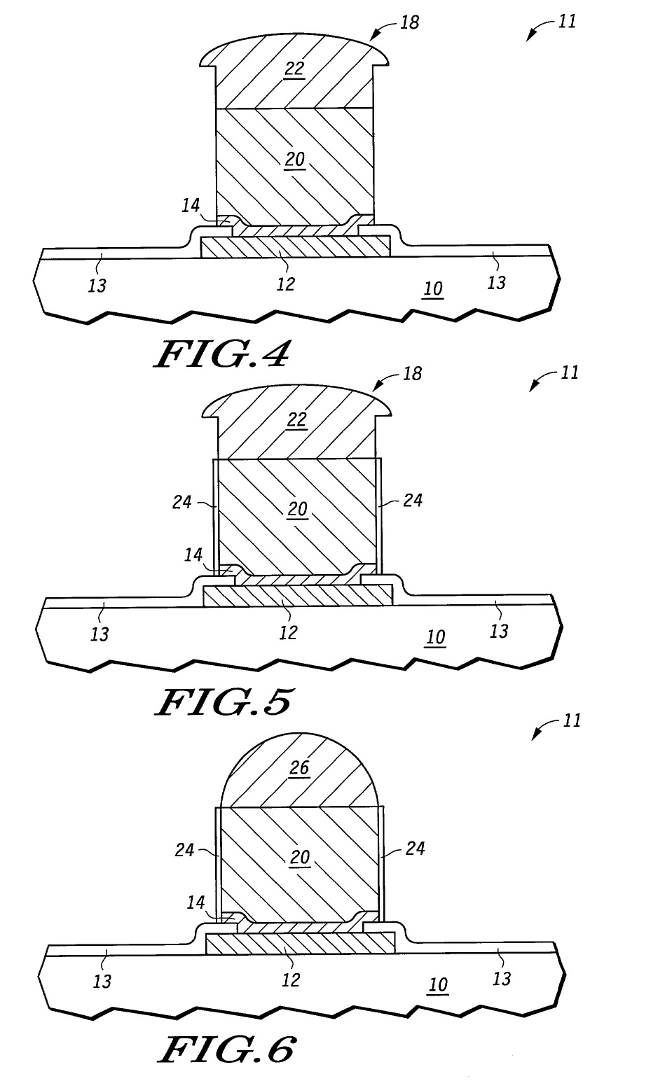

In FIG. 6, solder cap 22 may be optionally reflowed to form reflowed solder cap 26. During reflow, solder cap 22 temporarily transitions into a fluid state. Therefore, by forming nonwettable surfaces on the sides of standoff 20, the volume of solder cap 22 may be concentrated on the top of standoff 20 upon reflow. In alternate embodiments, solder cap 22 may not be reflowed prior to being attached to a substrate.

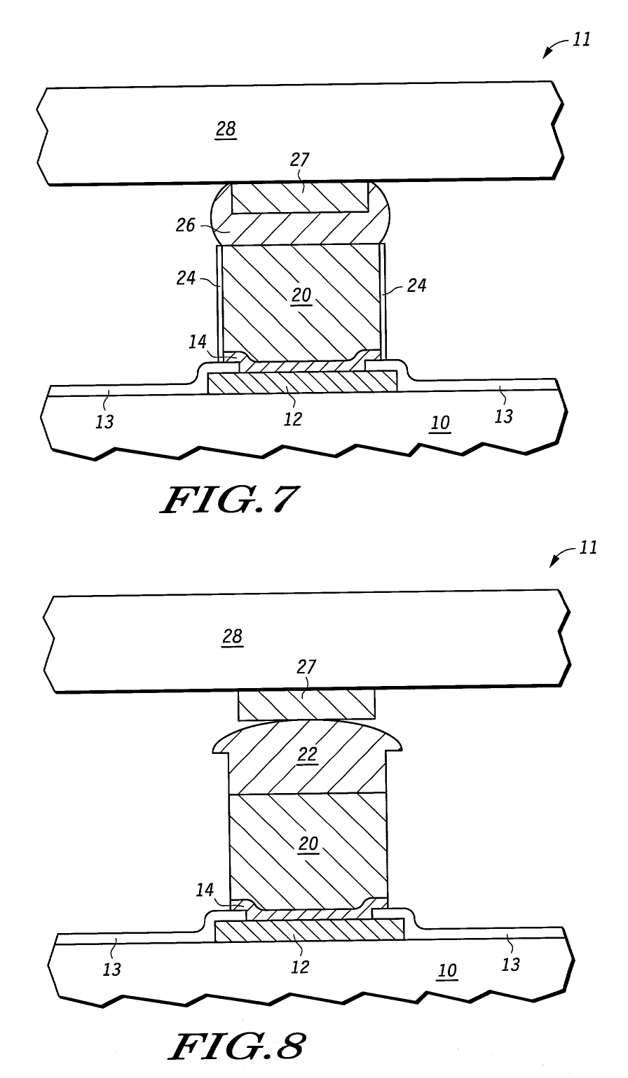

FIG. 7 illustrates one embodiment of a resulting flip-chip interconnect system. Substrate 28 includes an interconnect pad 27 that is attached to solder cap 22. (Alternatively, interconnect pad 27 is attached to reflowed solder cap 26 if the optional step of reflowing of FIG. 6 is used.) After attaching interconnect pad 27 to solder cap 22, the structure is reflowed to form the resulting interconnect system of FIG. 7 (where pad 27 is electrically coupled to solder cap 22). Note that substrate 28 may include organic or ceramic materials and provides an interconnect for semiconductor die 10 and a printed circuit board.

Therefore, the resulting structure of FIG. 7 with standoff 20 allows for finer pitches within the resulting flip-chip interconnect system. By concentrating the solder at the tip of standoff 20, interconnects may be formed closer together. Furthermore, the diameter of standoff 20 may be reduced to further reduce pitch. Also, the nonwettable surfaces allows for the volume of solder cap 22 to remain at the tip of standoff 20 which increases the reliability of the resulting interconnect system. A greater volume of solder allows for more reliable interconnects, even when the surface of substrate 28 or semiconductor die 10 may provide for uneven interconnects.

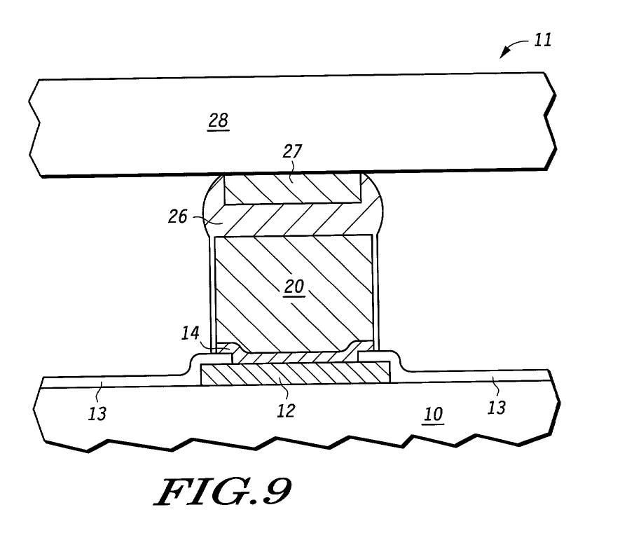

In an alternate embodiment, after removing masking layer 16 and portions of seed layer 14, as illustrated in FIG. 4, solder cap 22 may be attached to pad 27 of substrate 28. In this embodiment, solder cap 22 is not reflowed prior to attaching it to pad 27. After attaching solder cap 22 to pad 27, the resulting interconnect is reflowed to form the resulting interconnect system of FIG. 9. During reflow, insubstantial amounts of solder from solder cap 22 may be formed along the sides of standoff 20. For example, in one embodiment, no more than approximately 5% of solder cap 22 is lost along the sides of standoff 20. In an alternate embodiment, no more than approximately 2% of solder cap 22 is lost along the sides of standoff 20. Although some insubstantial volume of solder may be lost along the sides of standoff 20, this embodiment still allows for finer pitch and increased reliability.

In the foregoing specification, the invention has been described with reference to specific embodiments. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention.

Benefits, other advantages, and solutions to problems have been described above with regard to specific embodiments. However, the benefits, advantages, solutions to problems, and any element(s) that may cause any benefit, advantage, or solution to occur or become more pronounced are not to be construed as a critical, required, or essential feature or element of any or all the claims. As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed is:

1. An interconnect system, comprising:
a first substrate;
a standoff that extends from said first substrate, said standoff having sides and a first end opposite to said first substrate;
a cap that covers the first end of the standoff and does not cover the sides of the standoff, said cap being intended for subsequent reflow attachment; and
a nonwettable surface layer on the sides of said standoff such that said cap is prevented from substantially wetting the sides of the standoff when said cap is in a fluid state.

2. The interconnect system of claim 1, wherein said standoff is formed of a nonwettable material and wherein an adhesion layer is interposed between the cap and the nonwettable surface layer.

3. The interconnect system of claim 1, wherein said standoff is formed of a material selected from a group consisting of copper, gold and nickel.

4. The interconnect system of claim 1, wherein said cap comprises solder.

5. The interconnect system of claim 1, wherein at least a portion of said nonwettable surface layer comprises a grown oxide.

6. The interconnect system of claim 1, wherein at least a portion of said nonwettable surface layer comprises a residual oxide.

7. The interconnect system of claim 1, wherein said nonwettable surface layer is formed of a material selected from a group consisting of an oxide and photoresist.

8. The interconnect system of claim 7, wherein said nonwettable surface layer comprises a copper oxide layer and the standoff comprises copper.

9. The interconnect system as in claim 1, further comprising:
a second substrate electrically connected to the first substrate.

10. The interconnect system as in claim 9, wherein after connection of said second substrate, substantially all of said cap is located at the first end of said standoff and substantially none of said cap is located along the nonwettable surface layer.

11. An interconnect system, comprising:
a first substrate;
a standoff that extends from said first substrate, said standoff having sides and a first end opposite to said first substrate;
a cap that covers the first end of the standoff and does not cover the sides of the standoff, said cap being intended for subsequent reflow attachment;
a nonwettable surface layer over the sides of said standoff such that said cap is prevented from substantially wetting the sides of the standoff when said cap is in a fluid state; and
a second substrate attached to said cap, wherein after attachment of said second substrate, substantially all of said cap is located at the first end of said standoff.

12. The interconnect system of claim 11, wherein at least a portion of said nonwettable surface layer comprises an oxide.

13. The interconnect system of claim 11, wherein said standoff is formed of a nonwettable material and wherein an adhesion layer is interposed between the cap and the nonwettable surface layer.

14. A method of fabricating an interconnect system, the method comprising:
providing a first substrate;
forming a standoff that extends from the first substrate, the standoff having sides and a first end opposite to the first substrate;
forming a cap that covers the first end of the standoff and does not cover the sides of the standoff, the cap being exposed for subsequent reflow attachment; and
providing a nonwettable surface layer over the sides of the standoff such that the cap is prevented from substantially wetting the sides of the standoff when the cap is in a fluid state.

15. A method of fabricating an interconnect system as in claim 14, wherein said step of providing a nonwettable surface layer comprises the step of:
using photoresist as at least a portion of the nonwettable surface layer.

16. A method of fabricating an interconnect system as in claim 14, wherein said step of providing a nonwettable surface layer comprises the step of:
oxidizing the sides of the standoff.

17. A method of fabricating an interconnect system as in claim 16, wherein said step of oxidizing comprises the step of:
growing an oxide on the sides of the standoff.

18. A method of fabricating an interconnect system as in claim 16, wherein said step of oxidizing comprises the step of:
oxidizing the sides of the standoff during a process to remove material.

19. A method of fabricating an interconnect system as in claim 18, wherein said step of oxidizing the sides of the standoff during a process to remove material comprises a step of stripping photoresist.

20. A method of fabricating an interconnect system as in claim 18, wherein said step of oxidizing the sides of the standoff during a process to remove material comprises a step of etching.
